(19) United States
(12) Patent Application Publication
(10) Pub. No.: US 2013/0344217 A1
(43) Pub. Date: Dec. 26, 2013

(54) Sweetener Compositions and Methods of Making Same

(71) Applicants: Yong Luke Zhang, Burnaby (CA); Cunbiao Kevin Li, Burnaby (CA)

(72) Inventors: Yong Luke Zhang, Burnaby (CA); Cunbiao Kevin Li, Burnaby (CA)

(73) Assignee: GLG LIFE TECH CORPORATION, Vancouver (CA)

(21) Appl. No.: 13/977,561

(22) PCT Filed: Dec. 29, 2011
(86) PCT No.: PCT/CA11/01409

§ 371 Date: Sep. 10, 2013

(30) Foreign Application Priority Data
Dec. 29, 2010 (CN) 201010610309.4
Dec. 29, 2010 (CN) 201010610326.8
Dec. 29, 2010 (CN) 201010610330.4
Dec. 29, 2010 (CN) 201010610334.2

(51) Int. Cl. A23L 1/236

(52) U.S. Cl. CPC A23L 1/2363; A23L 1/2364
USPC 426/548; 426/658

(57) ABSTRACT

Natural steviol glycosides sweetener compositions comprise a blend of Rebaudioside C extract and at least one of Rebaudioside A extract and STV extract including methods for producing the same and uses thereof in foods, beverages, functional foods and nutraceuticals.

### FIELD OF THE INVENTION

The present invention relates generally to natural sweetener compositions comprising plant extracts methods for producing the same.

### BACKGROUND

In the food and beverage industry, there is a general preference for the consumption of sweet foods, and manufacturers and consumers commonly add sugar in the form of sucrose (table sugar), fructose or glucose to beverages, food, etc. to increase the sweet quality of the beverage or food item. Although most consumers enjoy the taste of sugar, sucrose, fructose and glucose are high calorie sweeteners. Many alternatives to these high calorie sweeteners are artificial sweeteners or sugar substitutes, which can be added as an ingredient in various food items.

Common artificial sweeteners include saccharin, aspartame, and sucralose. Unfortunately, these artificial sweeteners have been associated with negative side effects. Therefore, alternative. natural non-caloric or low-caloric or reduced caloric sweeteners have been receiving increasing demand as alternatives to the artificial sweeteners and the high calorie sweeteners comprising sucrose, fructose and glucose. Like some of the artificial sweeteners, these alternatives provide a greater sweetening effect than comparable amounts of caloric sweeteners; thus, smaller amounts of these alternatives are required to achieve sweetness comparable to that of sugar. These alternative, natural sweeteners, however, can be expensive to produce and/or possess taste characteristics different than sugar (such as sucrose), including, in some instances, undesirable taste characteristics such as sweetness linger, delayed sweetness onset, negative mouth feels and different taste profiles, such as off-tastes, including bitter, metallic, cooling, astringent, licorice-like tastes.

Steviol glycosides are responsible for the sweet taste of the leaves of the stevia plant (Stevia rebaudiana Bertoni). These compounds range in sweetness from 40 to 300 times sweeter than sucrose. They are heat-stable, pH-stable, and do not ferment.¹ They also do not induce a glycemic response when ingested, making them attractive as natural sweeteners to diabetics and others on carbohydrate-controlled diets. ¹ Brandle, Jim (2004 Aug. 19). “FAQ—Stevia, Nature's Natural Low Calorie Sweetener”. Agriculture and Agri-Food Canada. Retrieved 2006 Nov. 8.

Stevia rebaudiana, after extraction and refinement is extensively used in the fields of foods, beverages, alcoholic liquor preparation, medicines, cosmetics, etc. In recent years, Stevia rebaudiana glycosides as extracts of Stevia rebaudiana have been used even more popularly as natural sweeteners and attractive alternatives to artificial sweeteners. They have become an excellent sweetening option since their caloric value is extremely low and they do not cause adverse effects to dental patients and diabetic patients. The potential market is huge.

Stevia rebaudiana glycosides mainly comprise the following nine components: Stevioside, rebaudioside A (RA), rubusoside, dulcoside A, rebaudioside C (RC), rebaudioside F, rebaudioside D (RD), steviolbioside (STB), and rebaudioside B (RB).

The diterpene known as steviol is the aglycone of stevia's sweet glycosides, which are constructed by replacing steviol's carboxyl hydrogen atom with glucose to form an ester, and replacing the hydroxyl hydrogen with combinations of glucose and rhamnose to form an ether. The two primary compounds, stevioside and rebaudioside A, use only glucose: Stevioside has two linked glucose molecules at the hydroxyl site, whereas rebaudioside A has three, with the middle glucose of the triplet connected to the central steviol structure.

In terms of weight fraction, the four major steviol glycosides found in the stevia plant tissue are:
5-10% stevioside (250-300× of sugar)
2-4% rebaudioside A—most sweet (350-450× of sugar) and least bitter
1-2% rebaudioside C
½-1% dulcoside A.

Rebaudioside B, D, and E are known to be present in minute quantities.

Stevia diterpene glycosides, have a single base--steviol and differ by the presence of carbohydrate residues at positions C₁₃ and C₁₉. These glycosides accumulate in Stevia leaves and compose approximately 10%-20% of the total dry weight. Typically, on a dry weight basis, the four major glycosides found in the leaves of Stevia are Dulcoside A (0.3%), Rebaudioside C (0.6%), Rebaudioside A (3.8%) and Stevioside (9.1%). Other glycosides identified in Stevia extract include Rebaudioside B, C, D, E, and F, Steviolbioside and Rubusoside. Among steviol glycosides only Stevioside and Rebaudioside A are currently available in commercial scale.

The chemical structures of the diterpene glycosides of Stevia rebaudiana Bertoni are presented in FIG. 1. The physical and sensory properties are well studied generally only for Stevioside and Rebaudioside A. The sweetness potency of Stevioside is around 210 times higher than sucrose, Rebaudioside A in between 200 and 400 times, and Rebaudioside C and Dulcoside A around 30 times. Rebaudioside A is considered to have most favorable sensory attributes of the four major steviol glycosides (Table 1):

TABLE 1

| | | | | Optical | | | |
|---|---|---|---|---|---|---|---|
| | | | | rotation | | | |
| | | | | [α]²⁵_{D} | | | |
| | | T_{Me} [symbol] | Mol. | (H₂O, | Solubility | Relative | Quality of |
| Name | Formula | ° C. | Weight | 1%, w/v) | in water, % | sweetness | taste |
| Steviol | C₂₀H₃₀O₃ | 212-213 | 318.45 | ND | ND | ND | Very bitter |
| Steviolmonoside | C₂₆H₄₀O₈ | ND | 480.58 | ND | ND | ND | ND |
| Stevioside | C₃₈H₆₀O₁₈ | 196-198 | 804.88 | −39.3 | 0.13 | 210 | Bitter |
| Rebaudioside A | C₄₄H₇₀O₂₃ | 242-244 | 967.01 | −20.8 | 0.80 | 200-400 | Less Bitter |
| Rebaudioside B | C₃₈H₆₀O₁₈ | 193-195 | 804.88 | −45.4 | 0.10 | 150 | Bitter |
| Rebaudioside C | C₄₄H₇₀O₂₂ | 215-217 | 951.01 | −29.9 | 0.21 | 30 | Bitter |
| Rebaudioside D | C₅₀H₈₀O₂₈ | 248-249 | 1129.15 | −29.5 | 1.00 | 220 | Like sucrose |
| | | | | (ethanol) | | | |
| Rebaudioside E | C₄₄H₇₀O₂₃ | 205-207 | 967.01 | −34.2 | 1.70 | 170 | Like sucrose |
| Rebaudioside F | C₄₃H₆₈O₂₂ | ND | 936.99 | −25.5 | | ND | |
| | | | | (methanol) | | | |
| Dulcoside A | C₃₈H₆₀O₁₇ | 193-195 | 788.87 | −50.2 | 0.58 | 30 | Very bitter |
| Steviolbioside | C₃₂H₅₀O₁₃ | 188-192 | 642.73 | −34.5 | 0.03 | 90 | Unpleasant |
| Rubusoside | C₃₂H₅₀O₁₃ | ND | 642.73 | 642.73 | ND | 110 | Very bitter |

[symbol]

indicates data missing or illegible when filed

While there is increasing commercial interest in stevia glycosides and their natural sweetening properties, there are a number of limiting factors in their use, including, for some, bitter taste, varying sweetening capabilities and extraction costs/difficulties.

It is an object of the present invention to obviate or mitigate some or all of the above noted disadvantages.

### SUMMARY OF THE INVENTION

The present invention provides natural sweetener compositions comprising sweet steviol glycosides, methods for producing the same and uses thereof.

The present invention further provides a natural sweetener composition comprising a blend of Rebaudioside C extract along with one or both of Stevioside (STV) extract and Rebaudioside A extract.

In one aspect, the present invention provides a sweetness enhancing composition comprising rebaudioside C (Reb C) with both rebaudioside A (Reb A) and stevioside (STV). Such a composition takes advantage of Reb C (a pure, natural zero calorie sweetness enhancer with a particular rounded and refreshing taste and superior mouthfeel), but also overcomes the disadvantage of Reb A and STV having a bitter aftertaste.

In another aspect, the present invention provides a sweetness enhancing composition comprising rebaudioside C (Reb C) and rebaudioside A (Reb A). Such a composition takes advantage of Reb C (a pure, natural zero calorie sweetness enhancer with a particular rounded and refreshing taste and superior mouthfeel), but also overcomes the disadvantage of Reb A having a bitter aftertaste.

In another aspect, the present invention provides a sweetness enhancing composition comprising rebaudioside C (Reb C) and STV. Such a composition takes advantage of Reb C (a pure, natural zero calorie sweetness enhancer with a particular rounded and refreshing taste and superior mouthfeel), but also overcomes the disadvantage of STV having a bitter aftertaste.

The present invention further provides natural sweetener compositions comprising a blend of Rebaudioside C extract along with one or both of Stevioside (STV) extract and Rebaudioside A extract and further comprising one or more other natural sugars or sugar substitutes (includes natural sweeteners and artificial sweeteners).

The present invention further provides foods, beverages, nutraceuticals, medicinal formulations, cosmetics, health products, condiments and seasonings comprising a blend of Rebaudioside C extract along with one or both of Stevioside (STV) extract and Rebaudioside A extract.

The natural sweetener compositions of the present invention may be zero calories or merely reduced calorie, as desired.

What the present invention provides are compositions of specific and selected stevia glycosides which achieve benefits and advantages above and beyond the use of each extracted glycoside alone. These natural sweetener compositions have a taste profile comparable to sugar are desired, are not prohibitively expensive to produce and can be added, for example, to beverages and food products to satisfy consumers looking for a sweet taste. As such, these compositions allow for the customization of sweetening goals.

These and other objects and advantages of the present invention will become more apparent to those skilled in the art upon reviewing the description of the preferred embodiments of the invention, in conjunction with the figures and examples. A person skilled in the art will realize that other embodiments of the invention are possible and that the details of the invention can be modified in a number of respects, all without departing from the inventive concept. Thus, the following drawings, descriptions and examples are to be regarded as illustrative in nature and not limiting.

### DESCRIPTION OF THE DRAWINGS

Embodiments of the present invention will now be described, by way of example only, with reference to the attached Figures, wherein:

FIG. 1 shows the chemical structures of Reb C, Reb A and STV;

FIG. 2 is is a flow diagram of the extraction process for extracting a primary extract of steviol glycosides from the leaves of Stevia rebaudiana;

FIG. 3 is a flow diagram of the purification process for purifying Reb A extract from the primary extract of steviol glycosides extracted from the leaves of Stevia rebaudiana; and

FIG. 4 is a flow diagram of the purification process for purifying STV extract from the primary extract of steviol glycosides extracted from the leaves of Stevia rebaudiana.

### DETAILED DESCRIPTION OF THE INVENTION

A detailed description of one or more embodiments of the invention is provided below along with accompanying figures that illustrate the principles of the invention. As such this detailed description illustrates the invention by way of example and not by way of limitation. The description will clearly enable one skilled in the art to make and use the invention, and describes several embodiments, adaptations, variations and alternatives and uses of the invention, including what we presently believe is the best mode for carrying out the invention. It is to be clearly understood that routine variations and adaptations can be made to the invention as described, and such variations and adaptations squarely fall within the spirit and scope of the invention.

In other words, the invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

In the present disclosure and claims (if any), the word “comprising” and its derivatives including “comprises” and “comprise” include each of the stated integers or elements but does not exclude the inclusion of one or more further integers or elements. The term rebaudioside A may be used interchangeably with RA (or Reb A), the term rebaudioside C may be used interchangeably with RC (or Reb C) and the term steviolbioside may be used interchangeably with STV. For clarity, it is to be noted that “steviol glycosides” have been referred to as stevia, stevioside, and stevia glycoside in the scientific literature. Generally, the term, steviol glycosides has been adopted for the family of steviol derivatives with sweetness properties that are derived from the stevia plant. More recently, the term, stevia, is used more narrowly to describe the plant or crude extracts of the plant, while stevioside is the common name for one of the specific glycosides that is extracted from stevia leaves. As used herein, the term “about” in connection with a measured quantity, refers to the normal variations in that measured quantity, as expected by a skilled artisan making the measurement and exercising a level of care commensurate with the objective of measurement.

Natural sweetener compositions that have a taste profile comparable to sugar are desired. Further, a composition that is not prohibitively expensive to produce is preferred. Such a composition can be added, for example, to beverages and food products to satisfy consumers looking for a sweet taste. There is provided herein a sweetener composition comprising Rebaudioside C (Reb C) and one or both of and Rebaudioside A (Reb A) and Stevioside (STV) extracts wherein the Reb C, Reb A and STV extracts are extracted from stevia plants. The sweetener composition is a natural, healthy and safe alternative to artificial sweeteners and sucrose-, fructose- and glucose-based sweeteners. Furthermore, the sweetener composition has a good overall taste, has little or no associated bitterness and provides a calorie free or reduced calorie sweetener.

The genus Stevia consists of about 240 species of plants native to South America, Central America, and Mexico, with several species found as far north as Arizona, New Mexico, and Texas. They were first researched by Spanish botanist and physician Petrus Jacobus Stevus (Pedro Jaime Esteve), from whose surname originates the Latinized word stevia.

Reb C, STV (commonly referred to as stevia sugar) and Reb A are glycosides with highly effective sweet taste properties. In fact, these compounds range in sweetness up to 380 times sweeter than sucrose. They are safe, non-toxic heat-stable, pH-stable, and do not ferment making them very commercially workable in the manufacture of foods and beverages. Furthermore, they do not induce a glycemic response when ingested (they have zero calories, zero carbohydrates and a zero glycemic index), making them extremely attractive as natural sweeteners to diabetics. those on carbohydrate-controlled diets and to anyone seeking healthy alternatives. The glycemic index, or GI, measures how fast a food will raise blood glucose level. Choosing foods that produce zero fluctuations in blood glucose is an important component for long-term health and reducing risk of heart disease and diabetes. As such, use of the natural sweetener compositions of the present invention has enormous advantages over cane, beet and other sugars.

A sweetener composition comprising a blend of Reb C, and one or both of Reb A and STV extracts present in a specific ratio provides a more pleasing taste profile and sugar-like taste in comparison to compositions comprising only one of Reb C, Reb A extract or STV extract. Without being bound by theory, it appears that the extracts of the Reb C/Reb A, Reb C/STV and Reb C/.Reb A/STV steviol glycosides have a synergistic relationship when the moieties are blended together, most preferably in the specific ratios defined herein, such that the blend results in a taste profile that is more preferable to consumers than if any of the steviol glycoside extracts is used on their own.

It is clearly understood that during the stevia extraction process, as increasing levels of purity of various extracts are produced, the costs associated with achieving such increasing levels of purity also increases. Those skilled in the art will understand that purifying steviol glycoside extracts, including Reb C, Reb A and STV extracts, to higher levels of purity, especially purity levels greater than about 95%, can be very costly, which can be limiting on the use of these steviol glycosides in sweetener compositions.

Surprisingly, a sweetener composition comprising a blend of Reb C and one or both of Reb A and STV extracts, where the Reb C, Reb A and STV extracts each have lower levels of purity, have a very similar or near equivalent or better taste profile as each extract alone and extracted to a higher level of purity. The ability to produce sweetener compositions comprising a blend of lower purity Reb C, Reb A and STV facilitates lower production and manufacturing costs, a more streamlined extraction process, and an overall increase in the production of the sweetener composition. Extracts of varying purities can be used within the scope of the present invention.

In an alternative embodiment, present invention comprises a blend of Reb C and one or both of Reb A and STV extracts (hereinafter referred to as the “blends”) and in addition a secondary sweetening component. The secondary sweetening component is preferably selected from the group consisting of sucrose, erythritol, fructose, glucose, maltose, lactose, corn syrup (preferably high fructose), xylitol, sorbitol, or other sugar alcohols, inulin, miraculin, monetin, thaumatin and combinations thereof, and also non-natural sweeteners such as aspartame, neotame, saccharin, sucralose and combinations thereof Preferably, for a 50% reduced calorie table top product, the ratio of a secondary sweetening component (most preferably sucrose) to the blends is preferably about 24.7:1. Such a natural sweetener composition can easily be added to food products and beverages, or can be used as a table top sweetener. The ratio of secondary sweetening component to the blends is more preferably between about 5:1 and 1:1.

Various manufacturing processes yielding steviol glycosides have been described in the scientific and patent literature and a number of processes can be used to extract and purify RC, RA and STV for use within the various compositions of the present invention. The present invention in respect of the selected blends, is not necessarily limited to any one extraction and purification process. Typically, steviol glycosides are obtained by extracting leaves of Stevia rebaudiana Bertoni with hot water or alcohols (ethanol or methanol); the obtained extract is a dark particulate solution containing all the active principles plus leaf pigments, soluble polysaccharides, and other impurities. Some processes remove the “grease” from the leaves with solvents such as chloroform or hexane before extraction occurs. There are dozens of extraction patents for the isotation of steviol glycosides, such processes often being categorized the extraction patents into those based on solvent, solvent plus a decolorizing agent, adsorption and column chromatography, ion exchange resin, and selective precipitation of individual glycosides. Methods using ultrafiltration, metallic ions, supercritical fluid extraction with CO₂ and extract clarification with zeolite are found within the body of more recent patents.

Reb C may be isolated from plant material by a method as described in U.S. Pat. No. 4,361,697 as fully incorporated herein by reference or by the processes further described herein.

At the 68th Joint Expert Committee on Food Additives (“JECFA”) meeting in 2007, steviol glycosides were defined as the products obtained from the leaves of Stevia rebaudiana Bertoni.

As cited by JECFA, the typical manufacture starts with extracting leaves with hot water and the aqueous extract is passed through an adsorption resin to trap and concentrate the component steviol glycosides. The resin is washed with methanol to release the glycosides and the product is recrystallized with methanol. Ion-exchange resins may be used in the purification process. The final product is commonly spray-dried. Table 2 (at the conclusion of the disclosure) provides a product monograph of steviol glycosides, including chemical names, structures, methods of assay and sample chromatogram showing elution times of nine major glycosides, including Reb C, Reb A and STV.

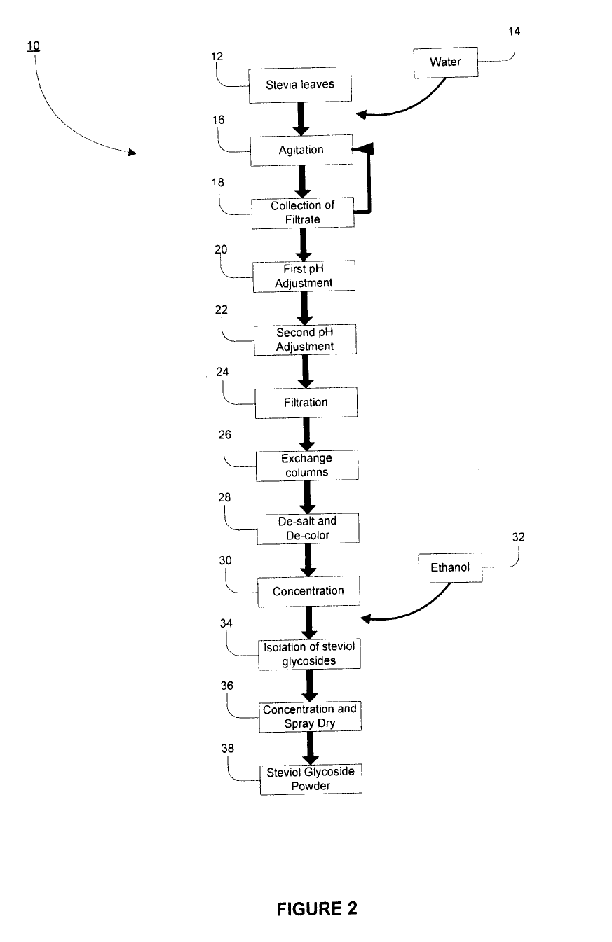

The following provides preferred steps of an extraction process used to isolate glycoside extracts from Stevia leaves. As shown in FIG. 2, the Reb A and STV extracts are isolated using the following steps. The Stevia leaves (12) are dried and the dried stevia leaves are agitated (16) in a volume of water (14) to release the sweet glycosides from the dried stevia leaves. Preferably, the sweet glycosides are released from the dried leaves using between about 1 volume to about 15 volumes of water. Even more preferably, the sweet glycosides are released from the dried leaves using about 12 volumes of water. The water-leaves mixture is agitated (16) for a period of time between about 10 minutes and about 1 hour, more preferably for a period of time between about 25 minutes and about 35 minutes. Following the agitation (16), the water-leaves mixture is drained and the filtrate collected (18). The cycle of agitation (16) and the collection of filtrate (18) is repeated for a total of about five cycles. Over the course of the five cycles, the water-leaves mixture is agitated for a total period of time between about 1 hour and about 5 hours, more preferably for a total period of time between about 2 hours and about 3 hours.

In one embodiment, for each agitation/collection cycle, the water-leaves mixture is agitated (16) in an environment having a temperature between about 5° C. and about 50° C., more preferably at a temperature between about 20° C. and about 30° C. Following the completion of the agitation/collection cycles, the pH of the water-leaves mixture is first adjusted to about pH 8.0 (20). The pH adjusted water/leaves mixture is then allowed to stand for a period of time between about 30 minutes and about two hours. The pH of the water-leaves mixture is then adjusted a second time (22) to about pH 7.0. The water-leaves mixture is subsequently filtered (24) to obtain an aqueous filtrate. The aqueous filtrate is then applied to ion exchange columns (26) to purify and decontaminate the aqueous filtrate. A person skilled in the art would understand that other methods may also be used to purify and decontaminate the aqueous filtrate. The aqueous filtrate is subsequently de-salted and de-colorized (28) and concentrated (30) using adsorption resin beds. A person skilled in the art would understand that other methods may also be used to concentrate the aqueous filtrate. A filtrate solution containing concentrated steviol glycosides is released from the adsorption resin beds (34) by rinsing the adsorption resin beds with ethanol (32), preferably about 70% ethanol (32). The filtrate solution is further concentrated and spray-dried (36) to produce a steviol glycosides containing powder (38), where the steviol glycosides include Reb A and STV. The concentration of steviol glycosides in the powder (38) varies depending on the stevia leaves (12) used, for example the concentration of RebA may be between about 24.3% to about 57.6% and the concentration of STV may be between about 24.7% to about 59.6%.

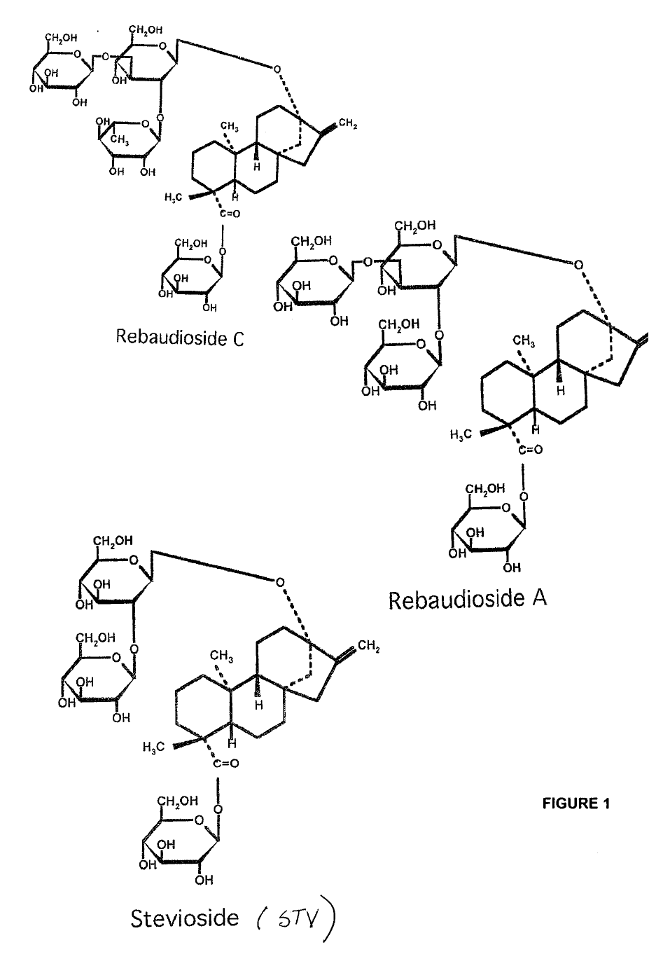

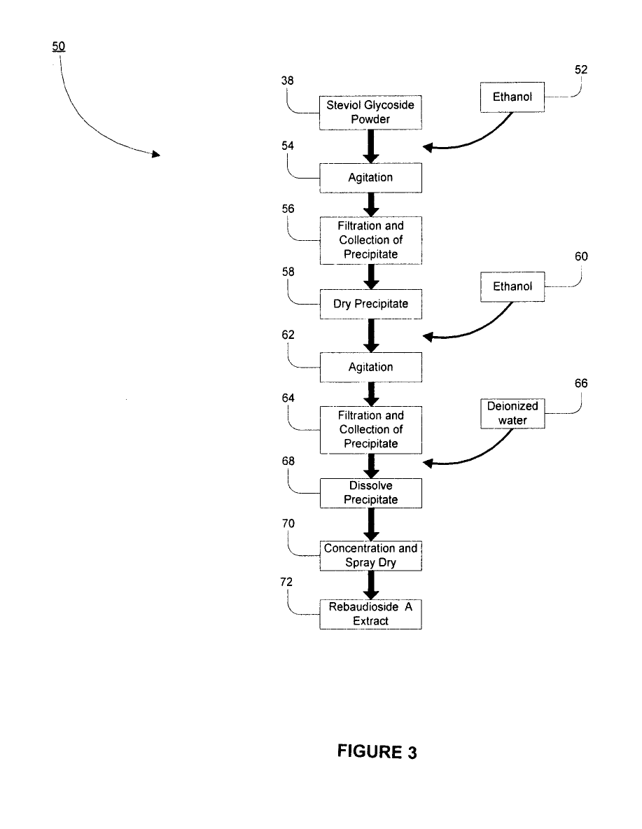

In one embodiment, Stevia leaves known to have a high content of Reb A are used to obtain a Reb A extract between about 60% and about 97.5% purity. Leaves known to have a high content of STV are used to obtain a STV extract between about 60% and about 97.5% purity. FIG. 3 illustrates a purification process (50) used to isolate Reb A extract from steviol glycoside powder (38) of FIG. 1. As shown in FIG. 3, Reb A extract is isolated using the following steps. Steviol glycoside powder (38), from the extraction process of FIG. 2, is mixed with ethanol (52), preferably between about 90% to about 95% ethanol, and the powder-ethanol mixture is agitated (54). The steviol glycoside powder (38) is mixed with preferably about two times volume (w/v) to about three times volume (w/v) of ethanol (52). Even more preferably, the steviol glycoside powder (38) is mixed with about two and a half times volume (w/v) of ethanol (52). The powder-ethanol mixture is agitated (54) for a period of time between about 30 minutes and about 2 hours, more preferably for a period of about one hour.

In one embodiment, the powder-ethanol mixture is agitated (54) in an environment having a temperature between about 25° C. and about 60° C., more preferably at a temperature between about 45° C. and about 50° C. The powder-ethanol mixture is subsequently filtered and the precipitate is collected (56). The precipitate is then dried (58). The precipitate is then mixed with ethanol (60). The ethanol (60) mixed with the precipitate is preferably between about 90% to about 95% ethanol, more preferably about 92% ethanol. Preferably, the precipitate is mixed with between about two times volume (w/v) to about four times volume (w/v) of ethanol (60).

Even more preferably, the precipitate is mixed with three times volume (w/v) of ethanol 60. The precipitate-ethanol mixture is slowly agitated (62) for a period of time between about 45 minutes and about 1 hour, more preferably for a period of about 50 minutes.

In one embodiment, the precipitate-ethanol mixture is agitated (62) in an environment having a temperature between about 25° C. and about 60° C., more preferably at a temperature between about 45° C. and about 50° C. Following agitation (62) of the precipitate-ethanol mixture, the precipitate-ethanol mixture is filtered and the precipitate is collected (64). The precipitate comprises crystals of RebA, preferably crystals of higher purity Reb A, even more preferably crystals of about 95% Reb A content. The precipitate is subsequently dissolved (68) in deionized water (66). The solution is then concentrated and spray-dried (70) to produce a final Reb A extract (72).

In one embodiment, the Reb A extract (72) is about 97.5% purity. A person skilled in the art would understand that other methods may also be used to dry the precipitate.

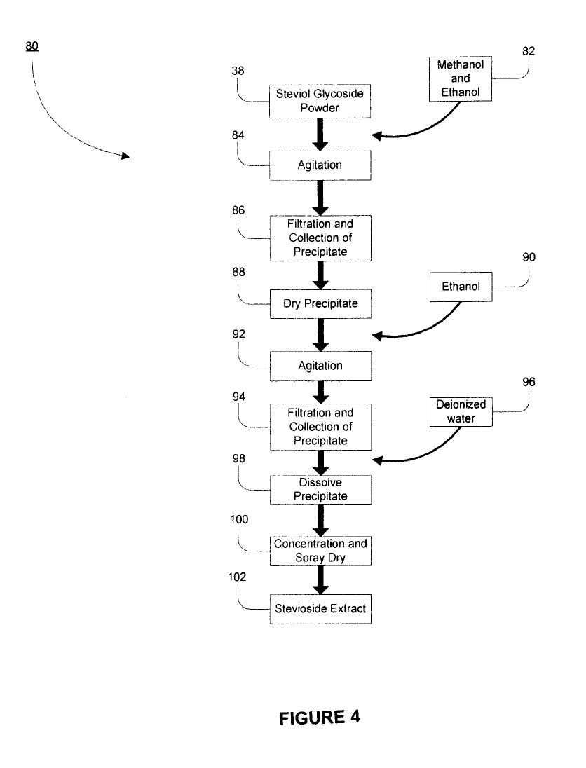

FIG. 4 illustrates a purification process (80) used to isolate STV extract from the steviol glycoside powder (38) of FIG. 1. As shown in FIG. 4, STV extract is isolated using the following steps. Steviol glycoside powder (38) is mixed with a mixture of methanol and ethanol (82). The ratio of methanol to ethanol in the methanol-ethanol mixture (82) is preferably about 4:1. Preferably, the steviol glycoside powder (38) is mixed with between about two times volume (w/v) to about four times volume (w/v) of the methanol-ethanol mixture (82). Even more preferably, the steviol glycoside powder (38) is mixed with about three times volume (w/v) of the methanol-ethanol mixture (82). The powder-methanol-ethanol mixture is agitated (84) for a period of time between about 30 minutes and about 2 hours, more preferably for a period of about one hour.

In one embodiment, the powder-methanol-ethanol mixture is agitated (84) in an environment having a temperature between about 25° C. and about 60° C., more preferably at a temperature between about 45° C. and about 50° C. The powder-methanol-ethanol mixture is subsequently filtered and the precipitate is collected (86). The precipitate is the dried (88). The precipitate is then mixed with ethanol (90). The ethanol (90) that is mixed with the precipitate is preferably between about 87% to about 95% ethanol, more preferably about 90% ethanol. Preferably, the precipitate-ethanol mixture is mixed with about one and a half times volume (w/v) to about two and half times volume (w/v) of ethanol (90). Even more preferably, the precipitate-ethanol mixture is mixed with two times volume (w/v) of ethanol (90). The precipitate-ethanol mixture is slowly agitated (92) for a period of time between about 45 minutes and about 1 hour, more preferably for a period of about 50 minutes.

In one embodiment, the precipitate-ethanol mixture is agitated (92) in an environment having a temperature between about 25° C. and about 60° C., more preferably at a temperature between about 45° C. and about 50° C. Following agitation (92) of the precipitate-ethanol mixture, the precipitate-ethanol mixture is filtered and the precipitate is collected (94). The precipitate comprises crystals of STV, preferably crystals of higher purity STV, even more preferably crystals of about 95% STV content. The precipitate is subsequently dissolved (98) in deionized water (96). The solution is then concentrated and spray-dried (100) to produce a final STV extract (102).

In one embodiment, the STV extract (102) is about 97.5% purity. A person skilled in the art would understand that other methods may also be used to dry the precipitate. Following the extraction process (10) shown in FIG. 2 and purification of Reb A extract (72) and STV extract (102), the Reb A extract (72) and STV extract (102) are blended for use in natural sweetener compositions. The sweetener compositions described above are : (a) low calorie or reduced calorie; (b) made from all natural products; (c) have a favourable safety profile; (d) demonstrate good thermal stability during processing; and (e) are less fermentable by oral dental-caries causative microorganisms than sugar.

The sweetener compositions of the present invention may be used in the preparation of various food products, beverages, medicinal formulations, chemical industrial products, among others. Exemplary applications/uses for the sweetener compositions include, but are not limited to: (a) food products, including canned food, preserved fruits, pre-prepared foods, soups, (h) beverages, including coffee, cocoa, juice, carbonated drinks, sour milk beverages, yogurt beverages, meal replacement beverages, and alcoholic drinks, such as brandy, whisky, vodka and wine; (c) grain-based goods—for example, bread and pastas, cookies, pastries, whether these goods are cooked, baked or otherwise processed; (d) fat-based products—such as margarines, spreads (dairy and non-dairy), peanut butter, peanut spreads, and mayonnaise; (d) Confectioneries—such as chocolate, candies, toffee, chewing gum, desserts, non-dairy toppings (for example Cool Whip®), sorbets, dairy and non-dairy shakes, icings and other fillings, (e) drug and medicinal formulations, particularly in coatings and flavourings; (f) cosmetics and health applications, such as for sweetening toothpaste; and (g) seasonings for various food products, such as soy sauce, soy sauce powder, soy paste, soy paste powder, catsup, marinade, steak sauce, dressings, mayonnaise, vinegar, powdered vinegar, frozen-desserts, meat products, fish-meat products, potato salad, bottled and canned foods, fruit and vegetables.

The natural sweetener compositions of the present invention may be formulated into premixes and sachets. Such premixes may then be added to a wide variety of foods, beverages and nutraceuticals. The purified natural sweetener compositions may, in one preferred form, be table top sweeteners.

The natural sweetener compositions may be used alone or in combination with other secondary sweeteners, as described herein, and/or with one or more organic and amino acids, flavours and/or coloring agents. Different products employ sweetener compositions having specific ratios of Reb C and one or more of Reb A extract to STV extract. These ratios are selected to achieve a high product quality, taste and flavour.

### Reb C and Reb A Blend

Reb A (Rebaudioside A) is one of the main sweet components of Stevia extract which is purely natural and has zero calories, and the sweetness thereof is 300-400 times of that of sucrose; however, when it is used alone, it has a very strong taste similar to that of liquorice root and an unsatisfactory mouthfeel.

Reb C (rebaudioside-C) is a purely natural sweetness enhancer, which has no sweet taste or calories per se and has a rounded and refreshing mouthfeel, and is capable of enhancing sweetness when it is used by compounding with sweeteners with calories and sweetness, further achieving the effect of reducing calories. For example, its compounding with sucrose or high fructose corn syrup can maintain the same sweetness thereof, and at the same time reduce calories by 25-50%. However, as far as Reb C itself is concerned, it has no range of sweetness at all. It has almost no taste when it is used in a small amount, but it will have an extremely strong bitter taste when it is used in a large amount.

The object of the present invention is to overcome the disadvantages in terms of mouthfeel of Reb A in applications, taking full advantage of Reb C as a sweetness enhancer that is purely natural and of zero calories and has a rounded and refreshing taste; therefore the compounding of Reb C with Reb A will make Reb A as the main sweet component of Stevia sugar have better mouthfeel, fresher taste, and be safer and more convenient to use.

The technical solution of the one aspect of present invention is a purely natural sweetener which is compounded from Reb C and Reb A, which is compounded by mixing the Reb C component of Stevia rebaudiana glycoside and the main sweet component Reb A of Stevia sugar.

The range of the weight ratio of rebaudioside C (Reb C) to rebaudioside A (Reb A) is about:

Reb C: Reb A=(1-50) parts:(50-99) parts.

The further technical solution of the present invention is to determine the optimal range for the selected weight ratio between the individual components of said purely natural sweetener which is compounded from Reb C and Reb A, based on the comprehensive analysis of such factors as mouthfeel, safety, costs, and convenience of use, etc., the optimal and preferred range for the ratio being about:

Reb C: Reb A=(10-50) parts:(50-90) parts.

The weight percentage of said Reb C accounts for 60-99% of the total Stevia rebaudiana glycoside, most preferably 80-97%. The weight percentage of said Reb A accounts for 80-99% of the total Stevia rebaudiana glycoside, most preferably 95-98%.

The efficacy of Reb C in the present invention lies not only in the fact that the sweetness of Reb A is enhanced, but also Reb C and Reb A act on taste sensors at the same time, so as to overcome the disadvantage of Stevia sugar in terms of mouthfeel, and at the same time maintain the advantages of being purely natural and having zero calories, high safety, and good heat stability during processing. The compounding of rebaudioside C (Reb C) and rebaudioside A (Reb A) can be widely applied to a variety of foods such as beverages, roasted foods, pickled foods, sweet foods, etc., which meets the need for sweet foods and the desire for health of general consumers.

The examples and advantageous effects are now described by means of the following list:

| | | | | | Added |
|---|---|---|---|---|---|
| | Compounding | Times | | Health | special |
| Example | ratio | sweeter | Mouthfeel | benefits | functions |
| 1 | Reb C:Reb A = | 650 | rounded and | zero calories | maintenance |
| | 1:1 | | refreshing | avoidance of | of normal |
| | | | | obesity, and | content of |
| | | | | prevention of | vitamins and |
| | | | | the occurrence | minerals in |
| | | | | of chronic | the body and |
| | | | | diseases such | enhancement |
| | | | | as diabetes, | of resistance |
| | | | | etc. | |
| 2 | Reb C:Reb A = | 475 | rounded and | zero calories | maintenance |
| | 1:3 | | refreshing | avoidance of | of normal |
| | | | | obesity, and | content of |
| | | | | prevention of | vitamins and |
| | | | | the occurrence | minerals in |
| | | | | of chronic | the body and |
| | | | | diseases such | enhancement |
| | | | | as diabetes, | of resistance |
| | | | | etc. | |
| 3 | Reb C:Reb A = | 417 | rounded and | zero calories | maintenance |
| | 1:5 | | refreshing | avoidance of | of normal |
| | | | | obesity, and | content of |
| | | | | prevention of | vitamins and |
| | | | | the occurrence | minerals in |
| | | | | of chronic | the body and |
| | | | | diseases such | enhancement |
| | | | | as diabetes, | of resistance |
| | | | | etc. | |
| 4 | Reb C:Reb A = | 370 | rounded and | zero calories | maintenance |
| | 1:9 | | refreshing | avoidance of | of normal |
| | | | | obesity, and | content of |
| | | | | prevention of | vitamins and |
| | | | | the occurrence | minerals in |
| | | | | of chronic | the body and |
| | | | | diseases such | enhancement |
| | | | | as diabetes, | of resistance |
| | | | | etc. | |

Notes:
1. The sweetness indicated in the table is the number of times sweeter than the same amount of sucrose.
2. The optimal proportion of Reb C indicated in the table accounts for 80-97% of the weight percentage of the total Stevia rebaudiana glycoside; and The optimal proportion of Reb A indicated in the table accounts for 95-98% of the weight percentage of the total Stevia rebaudiana glycoside.

### Reb C and STV:

STV (Stevioside) is one of the main sweet components of Stevia rebaudiana glycoside which is purely natural and has the sweetness thereof is 200 times higher than sucrose; however, when it is used alone, it has a very strong taste similar to that of liquorice root, a bitter aftertaste and a generally unsatisfactory mouthfeel.

As noted above, Reb C has no sweet taste or calories per se, but it is capable of enhancing sweetness when it is used by compounding with sweeteners with calories and sweetness.

Another aspect of the present invention is to overcome the disadvantages in terms of taste of STV in applications, taking full advantage of Reb C as a sweetness enhancer that is purely natural and of zero calories: the blend not only has improved taste, but also can reduce calories by 25-50% when it is compounded with sweeteners having calories. The preferred blend of STV compounded with Reb C gives STV a better mouthfeel, fresher taste, is safer, and more convenient to use, and at the same time meets consumer's demands for reducing the calories in diets.

The technical solution of this aspect of the present invention is a purely natural sweetener which is compounded by mixing Reb C and STV, which is made by mixing the Reb C component of Stevia rebaudiana glycoside and the main sweet component STV of Stevia rebaudiana glycoside. The preferred range of the weight ratio of Reb C to STV is about:

Reb C: STV=(1-50) parts:(50-99) parts.

The further technical solution of the present invention is to determine the optimal range for the selected weight ratio between the individual components of said purely natural sweetener which is compounded by mixing Reb C and STV, based on the comprehensive analysis of such factors as mouthfeel, safety, costs, and convenience of use, etc, the optimal range for the ratio being about:

Reb C:STV=(10-50) parts:(50-90) parts.

The weight percentage of said Reb C preferably accounts for 60-99% of the total Stevia rebaudiana glycoside, most preferably 80-97%. The weight percentage of said STV preferably accounts for 80-99% of the total Stevia rebaudiana glycoside, most preferably 95-98%.

The efficacy of Reb C in the present invention lies not only in the fact that the sweetness of STV is enhanced, but also Reb C and STV act on taste sensors at the same time, so as to overcome the disadvantages of Stevia sugar in terms of taste, and at the same time maintain the advantages of being purely natural and having zero calories, high safety, and good heat stability during processing. The compounding of Stevia rebaudiana glycoside Reb C and STV can be widely applicable to a variety of foods such as beverages, roasted foods, pickled foods, sweet foods, etc., which meets the need for sweet foods and the desire for health of general consumers.

The examples and advantageous effects are now described by means of following list:

| | | | | | Added |
|---|---|---|---|---|---|
| | Compounding | Times | | Health | special |
| Example | ratio | sweeter | Mouthfeel | benefits | functions |
| 1 | Reb C:STV = | 600 | rounded and | Zero calories | maintenance |
| | 1:1 | | refreshing | avoidance of | of normal |
| | | | | obesity, and | content of |
| | | | | prevention of | vitamins and |
| | | | | the occurrence | minerals in |
| | | | | of chronic | the body and |
| | | | | diseases such | enhancement |
| | | | | as diabetes, | of resistance |
| | | | | etc. | |
| 2 | Reb C:STV = | 400 | rounded and | Zero calories | maintenance |
| | 1:3 | | refreshing | avoidance of | of normal |
| | | | | obesity, and | content of |
| | | | | prevention of | vitamins and |
| | | | | the occurrence | minerals in |
| | | | | of chronic | the body and |
| | | | | diseases such | enhancement |
| | | | | as diabetes, | of resistance |
| | | | | etc. | |
| 3 | Reb C:STV = | 333 | rounded and | Zero calories | maintenance |
| | 1:5 | | refreshing | avoidance of | of normal |
| | | | | obesity, and | content of |
| | | | | prevention of | vitamins and |
| | | | | the occurrence | minerals in |
| | | | | of chronic | the body and |
| | | | | diseases such | enhancement |
| | | | | as diabetes, | of resistance |
| | | | | etc. | |
| 4 | Reb C:STV = | 280 | rounded and | Zero calories | maintenance |
| | 1:9 | | refreshing | avoidance of | of normal |
| | | | | obesity, and | content of |
| | | | | prevention of | vitamins and |
| | | | | the occurrence | minerals in |
| | | | | of chronic | the body and |
| | | | | diseases such | enhancement |
| | | | | as diabetes, | of resistance |
| | | | | etc. | |

Notes:
1. the sweetness indicated in the table is the number of times of sweeter than the same amount of sucrose.
2. the optimal proportion of Reb C indicated in the table is 80-97% of the weight percentage of Stevia rebaudiana glycoside; and The optimal proportion of STV indicated in the table is 95-98% of the weight percentage of Stevia rebaudiana glycoside.

### Reb C/Reb A/STV:

Another aspect of the present invention is to overcome the disadvantages in terms of taste of Reb A and STV in applications, taking full advantage of Reb C as a sweetness enhancer that is purely natural with zero calories and with a rounded and refreshing mouthfeel; it not only has an improved taste, but also can reduce calories by 25-50% when it is compounded with sweeteners containing calories; the compounding of Reb C with Reb A and STV achieves the effects of a better mouthfeel, fresher taste, greater safety, and greater convenience in use, and at the same time meets people's demands for reducing the amount of calories in their diets.

The technical solution of the present invention is a compounding of the sweetness enhancer Reb C with rebaudioside A (Reb A) and stevioside (STV), which is produced by mixing the Reb C component of Stevia rebaudiana glycoside and the main sweet components Reb A and STV of Stevia sugar. The preferred range of the weight ratio of said rebaudioside C (Reb C) to Reb A and STV is about:

Reb C:Reb A:STV=(1-50) parts:(37.5-74.75) parts:(12.5-24.75) parts.

The further technical solution of the present invention is to determine the optimal range for the selected weight ratio among the three components of said Stevia rebaudiana glycoside, based on comprehensive analysis of such factors as mouthfeel, safety, production costs, convenience of use, etc., the preferred optimal range for the ratio being about:

Reb C:Reb A:STV=(10-50) parts:(37.5-67.5) parts:(12.5-22.5) parts.

The weight percentage of said Reb C accounts for 60-99% of the total Stevia rebaudiana glycoside, preferably 80-97%; and the weight percentage of both Reb A and STV accounts for 80-99% of the total Stevia rebaudiana glycoside, preferably 95-98%.

The efficacy of Reb C in the present invention lies not only in the fact that the sweetness of Reb A and STV is enhanced, but also Reb C, Reb A and STV act on the taste sensors at the same time, so as to overcome the disadvantages of Stevia sugar in terms of taste, and at the same time maintain the advantages of being purely natural and having zero calories, high safety, and good heat stability during processing. The compounding of Reb C, Reb A and STV in Stevia rebaudiana glycoside can be widely applied to a variety of foods such as beverages, roasted foods, pickled foods, sweet foods, etc., which meets the need for sweet foods and the desire for health of general consumers.

The examples and advantageous effects are now described by means of the following list:

| | | | | | Added |
|---|---|---|---|---|---|
| | Compounding | Times | | Health | special |
| Example | ratio | sweeter | Mouthfeel | benefits | functions |
| 1 | Reb C:Reb A: | 638 | rounded and | zero calories | maintenance |
| | STV = 4:3:1 | | refreshing | avoidance of | of normal |
| | | | | obesity, and | content of |
| | | | | prevention of | vitamins and |
| | | | | the occurrence | minerals in |
| | | | | of chronic | the body and |
| | | | | diseases such | enhancement |
| | | | | as diabetes, | of resistance |
| | | | | etc. | |
| 2 | Reb C:Reb A: | 565 | rounded and | zero calories | maintenance |
| | STV = 8:9:3 | | refreshing | avoidance of | of normal |
| | | | | obesity, and | content of |
| | | | | prevention of | vitamins and |
| | | | | the occurrence | minerals in |
| | | | | of chronic | the body and |
| | | | | diseases such | enhancement |
| | | | | as diabetes, | of resistance |
| | | | | etc. | |
| 3 | Reb C:Reb A: | 420 | rounded and | zero calories | maintenance |
| | STV = 1:3:1 | | refreshing | avoidance of | of normal |
| | | | | obesity, and | content of |
| | | | | prevention of | vitamins and |
| | | | | the occurrence | minerals in |
| | | | | of chronic | the body and |
| | | | | diseases such | enhancement |
| | | | | as diabetes, | of resistance |
| | | | | etc. | |
| 4 | Reb C:Reb A: | 348 | rounded and | zero calories | maintenance |
| | STV = 4:27:9 | | refreshing | avoidance of | of normal |
| | | | | obesity, and | content of |
| | | | | prevention of | vitamins and |
| | | | | the occurrence | minerals in |
| | | | | of chronic | the body and |
| | | | | diseases such | enhancement |
| | | | | as diabetes, | of resistance |
| | | | | etc. | |

Notes:
1. The sweetness indicated in the table is the number of times sweeter than the same amount of sucrose.
2. Preferably the weight percentage of Reb C indicated in the table accounts for 80-97% of the total Stevia rebaudiana glycoside; preferably the weight percentage of both Reb A and STV indicated in the table accounts for 95-98% of the total Stevia rebaudiana glycoside.

Reb C with Natural Sweeteners (Optionally with Reb A and/or STV)

The present invention provides, in a further aspect, the combination of Reb C and optionally blends as described herein with one or more natural sweeteners.

Nowadays, people generally have a preference for sweet foods, and eating of sugar-containing foods is becoming a main method of energy intake. In recent years, problems caused by excessive intake of sugar are common all over the world, such as obesity, diabetes, hyperlipidemia, and dental caries in children. The World Health organization (WHO) has investigated the causes of death in population of 23 countries and drawn the conclusion that addiction to sugar is more harmful than smoking, and long-term consumption of foods with a high sugar content will make the life expectancy of people significantly shorter, and proposed the “quit sugar” slogan.

However, it is recognized that the absolute stopping of sugar intake is a difficult thing because almost all sweet foods are sweetened with a large amount of white sugar. Nevertheless, the excessive intake of white sugar affects the intake of other foods rich in proteins, vitamins, mineral substances, and dietary fibre. In the long term, this will lead to nutritional deficiencies, developmental disorders, obesity and other diseases. On the other hand, the metabolism of white sugar in the body necessitates the consumption of a variety of vitamins and mineral substances.

Therefore, frequent intake of sugar could cause nutritional problems such as vitamin deficiency, calcium deficiency, potassium deficiency and the like. Nutrition surveys also conclude that, although sugar intake may not lead to diabetes directly, long-term consumption of large amounts of sweet foods is likely to cause excessive insulin secretion and carbohydrate and fat metabolism disorders, which result in the imbalance in internal environment of the human body, thus promoting the onset of a variety of chronic diseases, such as cardiovascular and cerebrovascular diseases, diabetes, obesity, senile cataract, dental caries, myopia, and rickets.

Excessive intake of white sugar will also make human blood have the tendency to become acidic, which is not conducive to blood circulation and weakens the defense functions of the immune system. All of these factors heighten the need to reduce such white sugar intake and to seek to introduction of alternative sweetening agents.

Reb C is not a sweeter and is a sweetness enhancer, has low sweet taste or calories per se, but it is capable of enhancing sweetness when it is compounded with sweeteners with calories and sweetness, thus achieving the effect of reducing calories. For example, its compounding with sucrose or high fructose corn syrup can maintain the same sweetness thereof, and at the same time reduce calories by 25-50%.

As such, a further aspect of the present invention provides a solution to the problem of reduction of sugar intake while not sacrificing sweet taste. The present invention takes full advantage of the properties of Reb C as a purely natural sweetness enhancer, which composition provides a compounded sweetener comprising Reb C and one or more natural sweeteners (preferably but not exclusively sucrose) having a rounded and refreshing mouthfeel and 25-50% less calories. The present invention not only overcomes the disadvantages of high calories and health effects due to excessive intake of white sugar, but also utilizes fully the advantage of Stevia sugar in being purely natural, and having a high sweetness, and good safety and stability; and the compounded sweetener has a better mouthfeel and fresher taste, and is safer and more convenient for use, meeting people's demands for reducing calories in diets.

The technical solution of the present invention is a purely natural low-calorie compounded sugar which is compounded, in another preferred aspect, by mixing the rebaudioside C (Reb C) component of Stevia rebaudiana glycoside and sucrose. The range of the weight ratio of said rebaudioside C (Reb C) to sucrose is preferably about:

Reb C:sucrose=(0.05-10) parts:(90-99.95) parts.

The further technical solution of the present invention is to determine the optimal range for the selected weight ratio between the individual components of said novel low-calorie combined sugar, based on the comprehensive analysis of such factors as mouthfeel, safety, costs, and convenience of use, etc, the optimal range for the ratio preferably being about:

Reb C:sucrose=(0.05-5) parts:(95-99.95) parts.

The weight percentage of said Reb C accounts for preferably 60-99% of the total Stevia rebaudiana glycoside, most preferably 80-97%.

The purely natural low-calorie compounded sugar of the present invention is compounded by mixing rebaudioside C (Reb C) of Stevia rebaudiana glycoside and sucrose. Since white sugar after refinement has a very high purity, up to above 99%, this means that there is only a large amount of energy contained therein, with almost no other nutritional substances. Meanwhile, rebaudioside C (Reb C) is a sweetness enhancer extracted from Stevia rebaudiana, which is purely natural and highly safe, and has zero calories and good heat stability during processing. The rebaudioside C (Reb C) of Stevia rebaudiana glycoside is compounded with sucrose and is widely applicable to various foods such as beverages, roasted foods, pickled foods, and sweet foods.

The purely natural low-calorie composition described in the present invention can be processed using conventional food processing methods and the original appearance of sucrose can be maintained. Not only are the advantages of rebaudioside C (Reb C) in being purely natural and safe, and having sweetness enhancement and good stability ensured, but also the calorie value is reduced after compounding rebaudioside C (Reb C) of Stevia rebaudiana glycoside and sucrose, meeting the need for sweet foods and the desire for health of general consumers.

The examples and advantageous effects are now described by means of the following list:

| | | | | | Added |
|---|---|---|---|---|---|
| | Compounding | Times | | Health | special |
| Example | ratio | sweeter | Mouthfeel | benefits | functions |
| 1 | Reb C: | 2 | rounded and | low calories | maintenance |
| | sucrose = | | refreshing | avoidance of | of normal |
| | 0.1 parts: | | | obesity, and | content of |
| | 99.9 parts | | | prevention of | vitamins and |
| | | | | the occurrence | minerals in |
| | | | | of chronic | the body and |
| | | | | diseases such | enhancement |
| | | | | as diabetes, | of resistance |
| | | | | etc. | |
| 2 | Reb C: | 1.5 | rounded and | low calories, | maintenance |
| | sucrose = | | refreshing | avoidance of | of normal |
| | 0.05 parts: | | | obesity, and | content of |
| | 99.95 parts | | | prevention of | vitamins and |
| | | | | the occurrence | minerals in |
| | | | | of chronic | the body and |
| | | | | diseases such | enhancement |
| | | | | as diabetes, | of resistance |
| | | | | etc. | |
| 3 | Reb C: | 2.5 | rounded and | low calories, | maintenance |
| | sucrose = | | refreshing | avoidance of | of normal |
| | 0.15 parts: | | | obesity, and | content of |
| | 99.85 parts | | | prevention of | vitamins and |
| | | | | the occurrence | minerals in |
| | | | | of chronic | the body and |
| | | | | diseases such | enhancement |
| | | | | as diabetes, | of resistance |
| | | | | etc. | |
| 4 | Reb C: | 4 | rounded and | low calories, | maintenance |
| | sucrose = | | refreshing | avoidance of | of normal |
| | 0.3 parts: | | | obesity, and | content of |
| | 99.5 parts | | | prevention of | vitamins and |
| | | | | the occurrence | minerals in |
| | | | | of chronic | the body and |
| | | | | diseases such | enhancement |
| | | | | as diabetes, | of resistance |
| | | | | etc. | |

Notes:
1. the sweetness indicated in the table is the number of times sweeter than the same amount of sucrose.
2. the most preferable weight percentage of Reb C indicated in the table is 80-97% of total Stevia rebaudiana glycoside.

The means by which the sweetener compositions having specific ratios of Reb C and one or more of Reb A extract to STV extract will be added to, or incorporated in or on the food, beverage or other product will depend largely on the specific type of product. It is anticipated that such incorporation will occur at the time of manufacture of the food product, although in many cases, later addition may also be possible.

The sweetener compositions of the present invention may be used in the preparation of various food products, beverages, medicinal formulations, chemical industrial products, among others. Exemplary applications/uses for the sweetener compositions include, but are not limited to: (a) food products, including canned food, preserved fruits, pre-prepared foods, soups, (b) beverages, including coffee, cocoa, juice, carbonated drinks, sour milk beverages, yogurt beverages, meal replacement beverages, and alcoholic drinks, such as brandy, whisky, vodka and wine; (c) grain-based goods—for example, bread and pastas, cookies, pastries, whether these goods are cooked, baked or otherwise processed; (d) fat-based products—such as margarines, spreads (dairy and non-dairy), peanut butter, peanut spreads, and mayonnaise; (d) Confectioneries—such as chocolate, candies, toffee, chewing gum, desserts, non-dairy toppings (for example Cool Whip®), sorbets, dairy and non-dairy shakes, icings and other fillings, (e) drug and medicinal formulations, particularly in coatings and flavourings; (f) cosmetics and health applications, such as for sweetening toothpaste; and (g) seasonings for various food products, such as soy sauce, soy sauce powder, soy paste, soy paste powder, catsup, marinade, steak sauce, dressings, mayonnaise, vinegar, powdered vinegar, frozen-desserts, meat products, fish-meat products, potato salad, bottled and canned foods, fruit and vegetables.

The natural sweetener compositions of the present invention may be formulated into premixes and sachets. Such premixes may then be added to a wide variety of foods, beverages and nutraceuticals. The purified natural sweetener compositions may, in one preferred form, be table top sweeteners.

The natural sweetener compositions may be used alone or in combination with other secondary sweeteners, as described herein, and/or with one or more organic and amino acids, flavours and/or coloring agents. Different products employ sweetener compositions having specific ratios of Reb A extract to STV extract. These ratios are selected to achieve a high product quality, taste and flavour.

### Purities:

The natural sweetener composition of this invention, wherein the Rebaudioside A extract is between about 60% to about 97.5% purity more preferably between about 70% to about 97.5% purity, more preferably between about 80% to about 97.5% purity more preferably between about 90% to about 97.5% purity most preferably 95% purity.
The natural sweetener composition of this invention, wherein the STV extract is about 60% to about 97.5% purity more preferably between about 70% to about 97.5% purity, more preferably between about 80% to about 97.5% purity, more preferably between about 90% to about 97.5% purity and most preferably 95% purity.
The natural sweetener composition of this invention, wherein the Reb C extract is about 60% to about 97.5% purity more preferably between about 70% to about 97.5% purity, more preferably between about 80% to about 97.5% purity, more preferably between about 90% to about 97.5% purity and most preferably 95% purity.

While the forms of composition, method and process described herein constitute preferred embodiments of this invention, it is to be understood that the invention is not limited to these precise forms. As will be apparent to those skilled in the art, the various embodiments described above can be combined to provide further embodiments. Aspects of the present composition, method and process (including specific components thereof) can be modified, if necessary, to best employ the systems, methods, nodes and components and concepts of the invention. These aspects are considered fully within the scope of the invention as claimed. For example, the various methods described above may omit some acts, include other acts, and/or execute acts in a different order than set out in the illustrated embodiments.

Further, in the methods taught herein, the various acts may be performed in a different order than that illustrated and described. Additionally, the methods can omit some acts, and/or employ additional acts.

These and other changes can be made to the present systems, methods and articles in light of the above description. In general, in the following claims, the terms used should not be construed to limit the invention to the specific embodiments disclosed in the specification and the claims, but should be construed to include all possible embodiments along with the full scope of equivalents to which such claims are entitled. Accordingly, the invention is not limited by the disclosure, but instead its scope is to be determined entirely by the following claims.

1. A natural sweetener composition comprising a blend of Rebaudioside C extract and at least one of Rebaudioside A extract and STV extract.

2. The natural sweetener composition of claim 1, wherein the natural sweetener is at least one of i) zero calories and ii) reduced calorie.

3. (canceled)

4. The natural sweetener composition of claim 1, wherein the Rebaudioside A extract has a purity selected from the group consisting of:
between about 60% to about 97.5%;
between about 70% to 97.5%;
between about 80% to 97.5%; and
about 95%.

5-8. (canceled)

9. The natural sweetener composition of claim 1, wherein the STV extract has a purity selected from the group consisting of:
between about 60% to about 97.5%;
between about 70% to 97.5%;
between about 80% to 97.5%; and
about 95%.

10-13. (canceled)

14. The natural sweetener composition of claim 1 further comprising at least one secondary sweetener selected from the group consisting of sucrose, erythritol, fructose, glucose, maltose, lactose, corn syrup, xylitol, sorbitol, or other sugar alcohols, inulin, miraculin, monetin, thaumatin, aspartame, neotame, saccharin, sucralose and combinations thereof.

15. (canceled)

16. The natural sweetener composition of claim 14, wherein the secondary sweetener is sucrose and a percentage of sucrose in the composition is between about 1% and about 60%.

17. A method of enhancing sweetness in foods, beverages, nutraceuticals, medicinal formulations, cosmetics, health products, condiments and seasonings which comprises adding to said foods, beverages, nutraceuticals, medicinal formulations, cosmetics, health products, condiments and seasonings a natural sweetener composition comprising a blend. of Rebaudioside C extract and at least one of Rebaudioside A extract and STV extract.

18. The method of claim 17 wherein the natural sweetener composition additionally comprises at least one secondary sweetener selected from the group consisting of sucrose, erythritol, fructose, glucose, maltose, lactose, corn syrup, xylitol, sorbitol, or other sugar alcohols, inulin, miraculin, monetin, thaumatin, aspartame, neotame, saccharin, sucralose and combinations thereof.

19. A food product comprising a natural sweetener composition comprising a blend of Rebaudioside C extract and at least one of Rebaudioside A extract and STV extract.

20. (canceled)

21. A composition to compound sweetness comprising Reb C with rebaudioside A (Reb A) and stevioside (STV), wherein the weight percentage of Reb C accounts for 60-99% of the total Stevia rebaudiana glycoside, and the weight percentage of both Reb A and STV accounts for 80-99% of the total Stevia rebaudiana glycoside, preferably 95-98%.

22. The composition of claim 21 wherein the weight percentage of Reb C accounts for 80-97% of the total Stevia rebaudiana glycoside.

23. The composition of claim 21 wherein the weight percentage of both Reb A and STV accounts for 95-98% of the total Stevia rebaudiana glycoside.

24. The composition of claim 21 wherein the range of the weight ratio of said rebaudioside C (Reb C) to Reb A and STV is selected from the group consisting of:
i) Reb C:Reb A:STV =(1-50) parts:(37.5-74.75) parts:(24.75-12.5) parts; and
ii) Reb C:Reb A:STV =(10-50) parts:(37.5-67.5) parts:(22.5-12.5) parts.

25. (canceled)

26. A composition to compound sweetness comprising Reb C and Reb A, wherein the weight percentage of Reb C accounts for 60-99% of total Stevia rebaudiana glycoside, and the weight percentage of Reb A accounts for 80-99% of total Stevia rebaudiana glycoside.

27. The composition of claim 26 wherein the weight percentage of Reb C accounts for 80-97% of the total Stevia rebaudiana glycoside.

28. The composition of claim 26 wherein the weight percentage of Reb A accounts for 95-98% of the total Stevia rebaudiana glycoside.

29. The composition of claim 26 wherein the range of the weight ratio of said rebaudioside C (Reb C) to rebaudioside A (Reb A) is selected from the group consisting of:
i) Reb C:Reb A =(1-50) parts:(50-99) parts; and
ii) Reb C:Reb A =(10-50) parts:(50-90) parts.

30. (canceled)

31. A composition to compound sweetness comprising Reb C and STV, wherein the weight percentage of Reb C accounts for 60-99% of total Stevia rebaudiana glycoside and the weight percentage of STV accounts for 80-99% of total Stevia rebaudiana glycoside.

32. The composition of claim 31 wherein the weight percentage of Reb C accounts for 80-97% of the total Stevia rebaudiana glycoside.

33. (canceled)

34. The composition of claim 31 wherein the weight ratio of Reb C to STV is selected from the group consisting of:
i) Reb C:STV =(1-50) parts:(50-99) parts; and
ii) Reb C:STV =(10-50) parts:(50-90) parts.

35. (canceled)

36. A natural low-calorie compounded sugar composition to compound sweetness comprising Reb C, wherein the weight percentage of rebaudioside C (Reb C) accounts for 60-99% of total Stevia rebaudiana glycoside.

37. The composition of claim 36 wherein the weight percentage is 80-97%.

38. The composition of claim 36 wherein the weight ratio of said rebaudioside C (Reb C) to sugar is selected from the group consisting of:
i) Reb C:sugar =(0.05-10) parts:(90-99.95) parts; and
ii) Reb C:sugar =(0.05-5) parts:(95-99.95) parts.

39. (canceled)

40. The composition of claim 36 wherein the sugar is selected from the group consisting of sucrose, erythritol, fructose, glucose, maltose, lactose, corn syrup, xylitol, sorbitol, or other sugar alcohols, inulin, miraculin, monetin, thaumatin, aspartame, neotame, saccharin, sucralose and combinations thereof.

41-43. (canceled)

44. The composition of claim 36 composition additionally comprising at least one secondary sweetener selected from the group consisting of sucrose, erythritol, fructose, glucose, maltose, lactose, corn syrup, xylitol, sorbitol, or other sugar alcohols, inulin, miraculin, monetin, thaumatin, aspartame, neotame, saccharin, sucralose and combinations thereof
